(19) United States
(12) Patent Application Publication
(10) Pub. No.: US 2006/0207699 A1
(43) Pub. Date: Sep. 21, 2006

(54) Chameleon tires

(76) Inventor: Latara Hemingway, Pittsburgh, PA (US)

Correspondence Address: JAMES RAY & ASSOCIATES, 2640 PITCAIRN ROAD, MONROEVILLE, PA, 15146, US

(21) Appl. No.: 11/385,556

(22) Filed: Mar. 21, 2006

Related U.S. Application Data
(60) Provisional application No. 60/663,893, filed on Mar. 21, 2005.

(51) Int. Cl. B60C 11/24

(52) U.S. Cl. 152/154.2

(57) ABSTRACT

A device for alerting a motorist about potential tire problems, the device comprises a first strip disposed within a vehicular tire tread, which becomes exposed when such tread on such tire is worn to a warranty level and a second strip disposed in such vehicular tire tread beneath such first strip, which becomes exposed when such tread on such tire is worn to a level where such tire is unsafe for driving.

### CROSS REFERENCE TO RELATED APPLICATIONS

This application is closely related to and claims benefit from U.S. Provisional Application Ser. No. 60/663,893 filed Mar. 21, 2005.

### FIELD OF THE INVENTION

The present invention relates, in general, to a vehicular tire, and, more particularly, the present invention relates to a means disposed in a tire for alerting the user of potential problems with such tire.

### BACKGROUND OF THE INVENTION

Prior to the conception and development of the present invention, as is generally well known in the prior art, it was often difficult for a motorist to fully understand the condition of the tires on the vehicle. According to a report from the National Highway Safety Administration, nearly fifty percent of the 11,500 cars, pickup trucks, vans and sports utility vehicles that the Agency checked had at least one tire with half-worn treads, while another ten percent had at least one bald tire.

Many motorists do not check their tires or even bother to look at them and, thus, most motorists don't know when to change tires. This is probably true even for motorists that look at the tires. So many tires are at the point where the tread is low enough to become dangerous without the owner being aware of it. Unless the depth of the tread is measured one can only guess as to the status of the tires. Also if the tires are not aligned properly a portion of the tire may appear to be good while another portion may be worn to a dangerous level. Over inflated and under inflated tires can also lead to problems and many motorists are not aware of these problems.

Improper tire tread can lead to hydroplaning on a rainy or wet road and even worse problems during winter months. Slow leaks are also a problem which can leave the motorist stranded when the tire unexpectedly goes flat.

Thus, it would be advantageous if there were a means by which a motorist could become aware of potential tire problems without needing to go to a garage to find out the status of the tires.

### SUMMARY OF THE INVENTION

In a first aspect the present invention provides a device for alerting a motorist about potential tire problems; the device comprises a first strip disposed within a vehicular tire tread, which becomes exposed when such tread on such tire is worn to a warranty level and a second strip disposed in such vehicular tire tread beneath such first strip, which becomes exposed when such tread on such tire is worn to a level where such tire is unsafe for driving.

In a second aspect the present invention provides a device in combination with a vehicular tire, the improvement comprises a first strip disposed within a vehicular tire tread, such first strip is designed to become exposed when the tread on the tire is worn to a warranty level and a second strip disposed in the vehicular tire tread beneath such first strip, such second strip is designed to become exposed when the tread on the tire is worn to a level where such tire is unsafe for driving.

### OBJECTS OF THE INVENTION

It is, therefore, one of the primary objects of the present invention to provide device for alerting a motorist on the condition of their tires.

Another object of the present invention is to provide a device for alerting a motorist that the tires are at a warranty level. Still another object of the present invention is to provide a device for alerting a motorist that the tires have reached an unsafe level for driving.

Yet another object of the present invention is to provide a device for alerting a motorist that the tires have other potential problems such as wheel misalignment, improper balance, over inflation and under inflation.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective cutaway view of a vehicular tire showing the strips disposed within the tread of such tire for alerting a user of tire problems.

FIG. 2 is front view of a new tire.

FIG. 3 is a front view of a tire showing the wear when the tire is misaligned where the wear is on one side of the tire.

FIG. 4 is a front view of a tire showing the wear when the tire is misaligned in a different manner.

FIG. 5 is a front view of a tire showing the wear when the tire is not properly balanced.

FIG. 6 is a front view of a tire showing the wear when the tire is under inflated.

FIG. 7 is a front view of a tire showing the wear when the tire is over inflated.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention is designed to make motorists aware of the condition of their tires and to help prevent accidents or even deaths as the result of poor tire maintenance. Thus, in a first aspect the present invention provides a device, generally designated 10, for alerting a motorist about potential tire problems. The device 10 comprises a first strip 2 that is disposed within a vehicular tire tread 4, the first strip 2 is designed to become exposed when such tread 4 on such tire is worn to a warranty level and a second strip 6 disposed in such vehicular tire tread 4 beneath such first strip 2, such second strip 6 is designed to become exposed when such tread 4 on such tire is worn to a level where such tire is unsafe for driving.

As is evident in FIG. 1 both such first strip 2 and such second strip 6 extend throughout the tread surface and through such sidewall of such tire. Such first strip 2 has a predetermined color. It is preferred that such color is a fluorescent color so as to make the first strip 2 more easily visible. Such color is selected from any of the normal colors such as green, red, blue, yellow, pink and orange.

It is also preferred that such second strip 6 have a predetermined color and that such color is also fluorescent. Such color of such second strip is also selected from any of the normal colors such as green, red, blue, yellow, pink and orange. However, it is preferred that such color of such second strip 6 be different from the color selected for the first strip 2. One such combination could be a fluorescent yellow first strip 2 and a fluorescent green for such second strip 6. It is preferred that the first strip 2 be lighter in color than second strip 6.

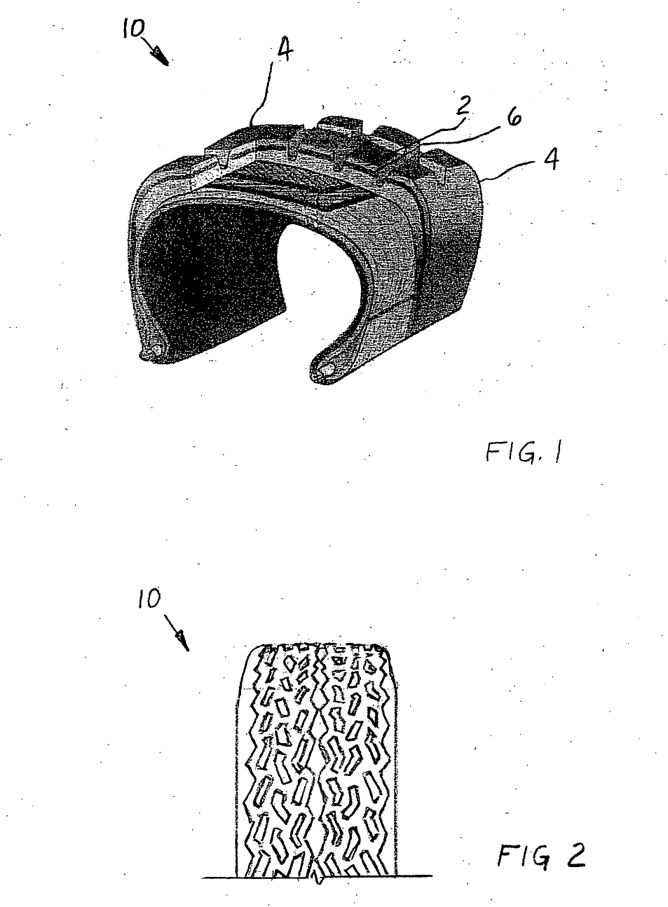

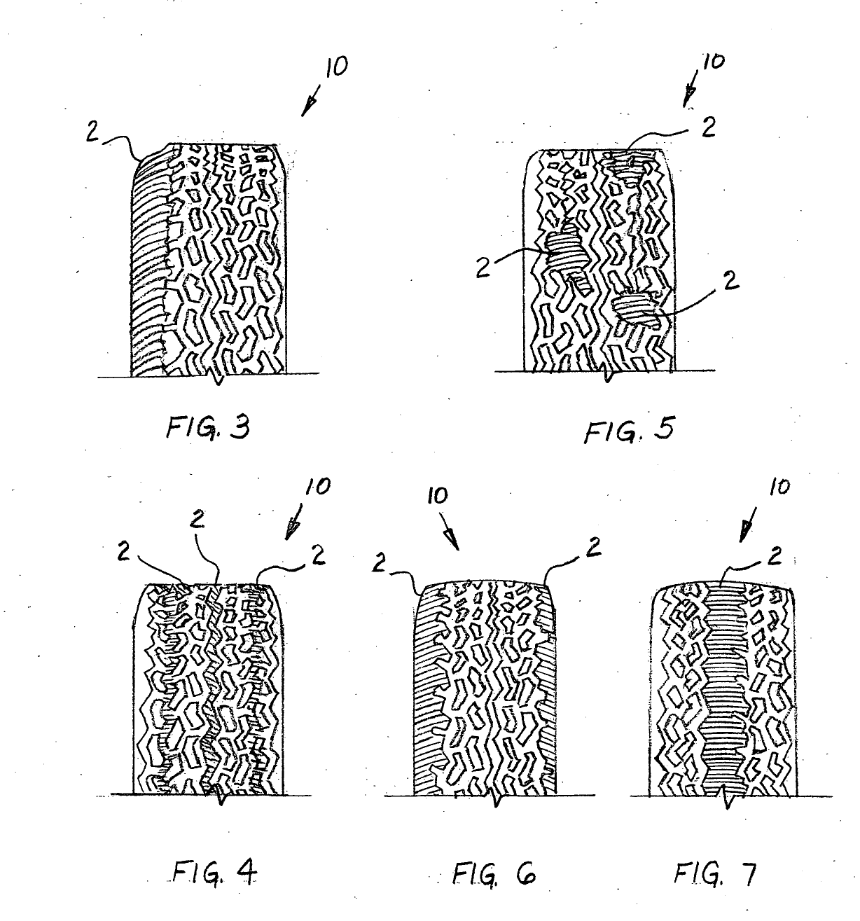

Such device 10 also alerts consumers of other potential tire problems. Illustrated in FIGS. 3-7 such tire problems would include wheel misalignment, improperly balanced tires, over inflated tires and under inflated tires. Examples of some of the possible wear patterns for these problems are seen in the drawing Figures. FIG. 2 shows the view of a new tire with no wear problems.

In a second aspect the present invention provides a device in combination with a vehicular tire, the improvement comprises a first strip 2 disposed within a vehicular tire tread, such first strip 2 is designed to become exposed when the tread on the tire is worn to a warranty level and a second strip disposed in the vehicular tire tread beneath such first strip, such second strip is designed to become exposed when the tread on the tire is worn to a level where such tire is unsafe for driving.

Similarly, as discussed previously with the first aspect, such first strip 2 has a predetermined color. It is preferred that such color is a fluorescent color so as to make the first strip 2 more easily visible. Such color is selected from any of the normal colors such as green, red, blue, yellow, pink and orange.

It is also preferred that such second strip 6 have a predetermined color and that such color is also fluorescent. Such color of such second strip is also selected from any of the normal colors such as green, red, blue, yellow, pink and orange. However, it is preferred that such color of such second strip 6 be different from the color selected for the first strip 2. One such combination could be a fluorescent yellow first strip 2 and a fluorescent green for such second strip 6.

Such device 10 also alerts consumers of other potential tire problems. Illustrated in FIGS. 3-7 such tire problems would include wheel misalignment, improperly balanced tires, over inflated tires and under inflated tires. Examples of some of the possible wear patterns for these problems are seen in the drawing Figures.

Thus, the color change that becomes visible alerts the driver of a tire problem. The first color change alerts the user that the tread is worn to the warranty level. The second color change warns the driver that the tire is no longer safe for driving. It is easier to spot any problems with the tires by seeing a change in color. Other potential problems are also visible to the user by seeing the color change. If a tire would happen to have a deep cut in the tire, the colored layer would become evident and the user would be alerted. The present invention can help the motorist be safe on the road by making the driver aware of tire problems and may prevent failing a safety inspection by warning the driver beforehand. Such a device can be used on other than automobile tires as it can be applied to motorcycle tires, airplane tires and even the tires on motorized wheelchairs.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. A device for alerting a motorist about potential tire problems; said device comprising:
(a) a first strip disposed within a vehicular tire tread, said first strip is designed to become exposed when such tread on such tire is worn to a warranty level; and
(b) a second strip disposed in such vehicular tire tread beneath said first strip, said second strip is designed to become exposed when such tread on such tire is worn to a level where such tire is unsafe for driving.

2. The device, according to claim 1, wherein said first strip has a first predetermined color.

3. The device, according to claim 2, wherein said first predetermined color is a fluorescent color.

4. The device, according to claim 3, wherein said first predetermined color is selected from green, red, blue, yellow, pink and orange.

5. The device, according to claim 2, wherein said second strip has a second predetermined color.

6. The device, according to claim 5, wherein said second predetermined color is different from said first predetermined color.

7. The device, according to claim 5, wherein said second predetermined color is fluorescent.

8. The device, according to claim 7, wherein said second predetermined color is selected from green, red, blue, yellow, pink and orange.

9. The device, according to claim 1, wherein said device also alerts consumers of other potential tire problems, such tire problems include wheel misalignment, improperly balanced tires, over inflated tires and under inflated tires.

10. In combination with a vehicular tire, the improvement comprising:
(a) a first strip disposed within a vehicular tire tread, said first strip is designed to become exposed when said tread on said tire is worn to a warranty level; and
(b) a second strip disposed in said vehicular tire tread beneath said first strip, said second strip is designed to become exposed when said tread on said tire is worn to a level where said tire is unsafe for driving.

11. The combination, according to claim 10, wherein said first strip has a first predetermined color.

12. The combination, according to claim 11, wherein said first predetermined color is a fluorescent color.

13. The combination, according to claim 12, wherein said first predetermined color is selected from green, red, blue, yellow, pink and orange.

14. The combination, according to claim 10, wherein said first strip and said second strip also alerts consumers of other potential tire problems, such tire problems include wheel misalignment, improperly balanced tires, over inflated tires and under inflated tires.
